(19) United States
(12) Patent Application Publication
(10) Pub. No.: US 2026/0034702 A1
(43) Pub. Date: Feb. 5, 2026

(54) Electric Power Tool

(71) Applicant: YAMABIKO CORPORATION, Tokyo (JP)

(72) Inventor: Kenji NAKANO, Ohme-shi (JP)

(21) Appl. No.: 19/272,021

(22) Filed: Jul. 17, 2025

(30) Foreign Application Priority Data
Jul. 31, 2024 (JP) 2024-124544

(51) Int. Cl. B27B 17/08

(52) U.S. Cl. CPC B27B 17/08

(57) ABSTRACT

An electric power tool is provided that is configured to prevent water such as rainwater from coming into contact with connection terminals to which a battery is electrically connected, while also suppressing accumulation of heat generated by the battery. The electric power tool includes a main body section including: a battery compartment configured to form a gap opening upward with respect to the battery in a state where the battery is inserted from above, and a cover attached to the battery compartment so as to cover the battery from above, the cover being configured to expose the gap to outside when attached to the battery compartment; and an electric work section provided at a front side of the main body section and configured to operate with power supplied from the battery.

### CROSS REFERENCE TO RELATED APPLICATIONS

The present application claims priority under 35 U.S.C. § 119 to Japanese Patent Application No. 2024-124544, filed on Jul. 31, 2024, the contents of which are incorporated herein by reference in their entirety.

### BACKGROUND

### Technical Filed

The present disclosure relates to an electric power tool.

### RELATED ART

JP2022-21558A discloses a chainsaw. This chainsaw includes a motor, a housing in which the motor is disposed, a battery pack detachably mounted to the housing and electrically connected to the motor, and a cover that is connected to the housing and configured to cover the battery pack in an openable manner.

In this chainsaw, the housing is sealed when the battery pack is covered by the cover. Therefore, although rainwater or the like can be prevented from coming into contact with the connection terminals electrically connected to the battery pack, heat generated by the battery pack may accumulate inside the housing, potentially causing the battery pack to cease operation for safety reasons.

In view of the above circumstances, the present disclosure provides an electric power tool configured to prevent water such as rainwater from coming into contact with connection terminals to which the battery is electrically connected, while also suppressing accumulation of heat generated by the battery.

### SUMMARY

According to one aspect of the present disclosure, an electric power tool, including: a main body section including: a battery compartment configured to form a gap opening upward with respect to a battery in a state where the battery is inserted from above, and a cover attached to the battery compartment so as to cover the battery from above, the cover being configured to expose the gap to outside when attached to the battery compartment; and an electric work section provided at a front side of the main body section and configured to operate with power supplied from the battery, is provided.

According to such an arrangement, water such as rainwater can be prevented from contacting the connection terminal, and the accumulation of heat generated from the battery can be suppressed.

### BRIEF DESCRIPTION OF THE DRAWINGS

FIG. 1 is a left side view showing the overall configuration of the chainsaw.

FIG. 2 shows the chainsaw from above.

FIG. 3 shows the chainsaw from below.

FIG. 4 is an enlarged view of a portion of a cross-section taken along line A-A cross section in FIG. 2.

FIGS. 5A and 5B show another configuration example of the cover.

FIGS. 6A and 6B show another configuration example of the cover.

### DETAILED DESCRIPTION

The following drawings are used to describe the embodiment of the electric power tool. The various features shown in the following embodiments can be combined with each other.

In the following, a chainsaw for cutting trees, boards, and the like will be represented as an example of an electric power tool.

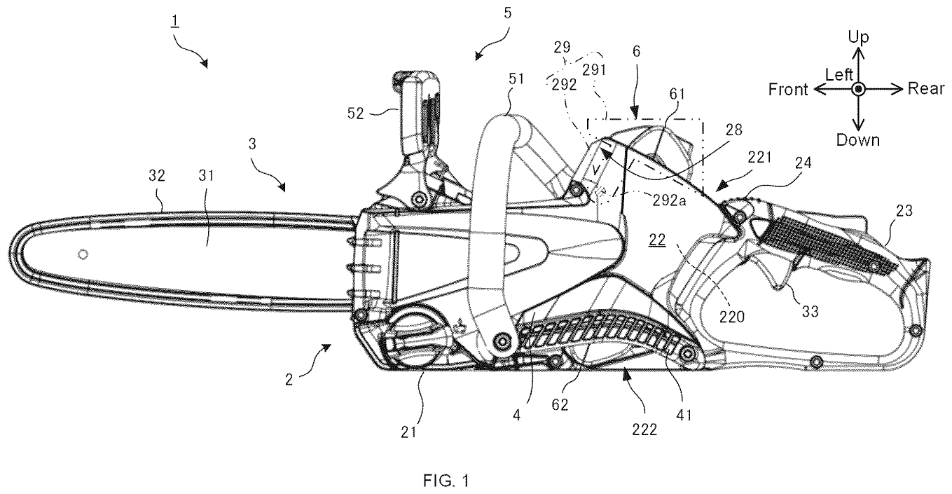

FIG. 1 is a left side view showing the overall configuration of the chainsaw.

In the present specification, the vertical direction, front-rear direction, and left-right directions are defined as shown in the figure.

Specifically, in the chainsaw 1, the vertical direction is defined as the direction perpendicular to a flat and horizontal installation surface when the chainsaw is placed thereon. In addition, the front-rear direction is defined as the direction orthogonal to the vertical direction, and the left-right direction is defined as the direction orthogonal to both the vertical direction and the front-rear direction.

The chainsaw 1 includes a main body section 2, an electric work section 3, an air intake section 4, a handle portion 5, and a battery 6.

The electric work section 3 is provided at the front side of the main body section 2 and is configured to operate using electric power supplied from the battery 6 when the operator performs a task with the chainsaw 1. Through this operation, the electric work section 3 directly acts on the work object. Here, the work performed by the operator is, for example, cutting trees, boards, and the like.

The electric work section 3 includes a guide bar 31, a saw chain 32, and a lever 33. The guide bar 31 is a plate-like member that extends in the front-rear direction, and the rear end thereof is attached to the main body section 2. The annular saw chain 32 is wound around the outer peripheral portion of the guide bar 31.

Although not shown in FIG. 1, the main body section 2 contains the control board, drive gear, motor controller, and the like.

The saw chain 32 is engaged with the drive gear. The drive gear is rotationally driven by the motor.

The control board executes a control process that controls the rotation of the motor by the lever 33 is operated.

With the above configuration, when the operator operates the lever 33, the motor controlled by the control board rotates the drive gear, and the resulting rotational force causes the saw chain 32 to rotate along the outer periphery of the guide bar 31.

The main body section 2 is formed of a resin material or the like and serves as a housing (also referred to as a “case”) that contains the aforementioned motor and other components. The main body section 2 includes a bottom surface portion 21, a battery compartment 22, and a rear handle 23.

The bottom surface portion 21 is the portion that contacts the installation surface when the chainsaw 1 is placed on a flat installation surface. In the present embodiment, the bottom surface portion 21 includes a flat surface in contact with the installation surface, but the chainsaw 1 may remain stable when placed on the installation surface, and the shape may be one that contacts the installation surface at multiple sides or points.

The battery 6 is inserted into the battery compartment 22 from above for installation. The rear handle 23 is provided at the rear of the main body section 2 and is a portion to be gripped by the operator when performing electrical work. The rear handle 23 is an elongated rod-shaped portion in the front-rear direction and is formed with dimensions suitable for being easily gripped by the operator's hand.

The air intake section 4, which includes an air intake port 41, forms a passage through which air introduced from the air intake port 41 is guided into the interior of the main body section 2 as cooling air.

The handle portion 5 includes the front handle 51 and a front hand guard 52. The front handle portion 51 is provided on the front side of the main body section 2 and is a portion to be gripped by the operator during electrical work. The front handle portion 51 extends from the upper side to the left side of the main body section 2, and is configured to allow the operator to change grip when cutting the object vertically or horizontally.

The front hand guard 52 protects the operator's hand gripping the front handle 51 from injury and also functions as a brake for stopping the operation of the electric work section 3.

As described above, the operator of the chainsaw 1 carries the main body section 2 by holding the front handle 51 and rear handle 23 and rotates the saw chain 32 to work on a work object such as a tree.

In the chainsaw 1, the side of the saw chain 32 where work is performed is defined as the front side, and the side of the rear handle 23 that is gripped by the operator is defined as the rear side, and the directions pointing to the front side and rear side are defined as the front-rear direction. In addition, when viewed from the rear side toward the front side, the leftward direction and the rightward direction are defined as the left-right direction.

The battery 6 has an elongated external shape. This battery 6 is inserted from the upper side into the storage space 220 of the battery compartment 22, with the longitudinal direction thereof serving as the insertion direction. Hereinafter, when the battery 6 is inserted into the battery compartment 22, the end located on the upper side is referred to as the upper end 61, and the end located on the lower side is referred to as the lower end 62. On the other hand, the battery 6 is removed upward along the takeout direction that is opposite to the insertion direction.

The battery compartment 22 includes a storage space 220 into which the battery 6 can be inserted from above, which detachably holds the battery 6 inserted into the storage space 220. The storage space 220 includes the first opening 221 on the upper side through which the battery 6 passes during insertion, and a second opening 222 on the lower side opposite to the first opening 221. The second opening 222 is provided with a size that allows a worker's finger to pass through.

According to this aspect, when an operator inserts a finger into the second opening 222 and pushes the lower end 62 of the battery 6, a force can be applied to the battery 6 in the removal direction (upward), making it easier to remove the battery 6 than in the case where the second opening 222 is not provided. In addition, since providing the second opening 222 is easier than providing, for example, an extraction mechanism with a spring portion and a lever, the battery can be easily removed from the chainsaw 1 with a simpler configuration.

The first opening 221 is where the storage space 220 opens to the outside on the upper end 61 side of the battery 6. The second opening 222 is where the storage space 220 opens to the outside at the lower end 62 of the battery 6. That is, when the battery compartment 22 of the main body section 2 is placed with the bottom surface portion 21 facing downward, the second opening 222 is positioned lower than the first opening 221. According to this configuration, the battery 6 can be inserted into the storage space 220 by the own weight thereof. Therefore, compared to the case where the positional relationship between the first opening 221 and the second opening 222 is reversed, the battery 6 can be more easily inserted.

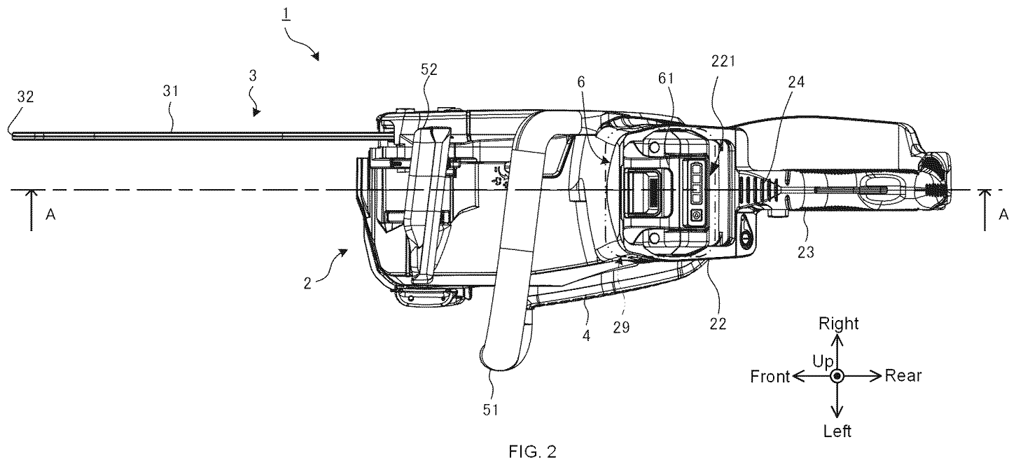

As shown in FIG. 2, the main body section 2 is provided with a non-slip 24 at the rear side of the first opening 221 (battery compartment 22). The non-slip 24 is formed by a plurality of ribs, each extending in the left-right direction. The non-slip 24 is a portion that contacts the operator's thumb when gripping the rear handle 23, and the operator's fingers when removing the battery 6, which is configured to reduce the likelihood of the operator's fingers slipping.

The non-slip 24 is not limited to a plurality of ribs, and may be, for example, a surface provided with a plurality of protrusions, a plurality of depressions, or a file-like texture such as a double-cut or wavy-cut pattern.

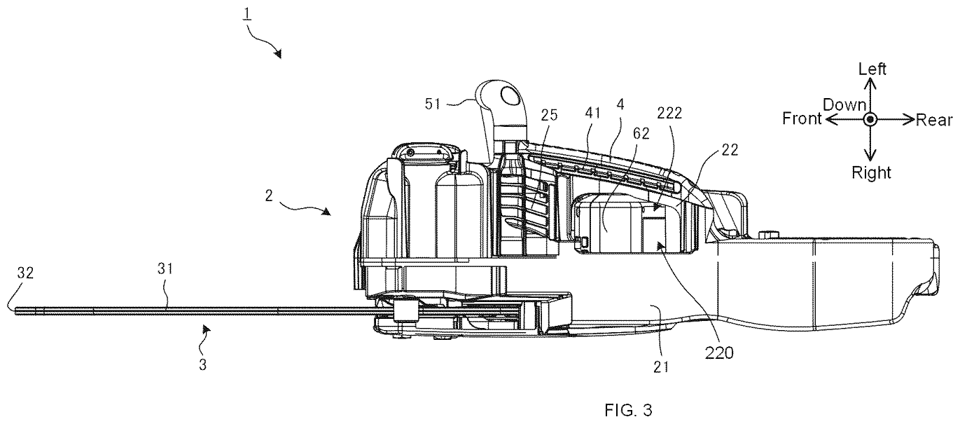

In addition, as shown in FIG. 3, the main body section 2 is provided with an exhaust port 25 on the front side of the second opening 222. The exhaust port 25 discharges to the outside the air (cooling air) that is taken in from the air intake port 41 and used to cool heat-generating components such as a motor and a control board arranged inside the main body section 2.

As described above, the battery compartment 22 includes a second opening 222 located on the lower end side 62 of the battery 6. Here, the length (dimension) of the battery 6 in the left-right direction is greater than length (dimension) of the second opening 222 in the left-right direction. In other words, a part of the lower end 62 of the battery 6 is covered by the bottom surface portion 21.

Thus, the second opening 222 has a shape and size such that the battery 6 inserted into the storage space 220 is prevented from passing through by the bottom surface portion 21 or the like. According to this aspect, the structural strength of the main body section 2 can be more easily ensured than in a case where the second opening 222 has a shape and size that allows the battery 6 to pass through such as the first opening 221.

In addition, the exhaust port 25 is located between the electric work section 3 and the second opening 222. According to this aspect, foreign matter such as sawdust generated during operation can be prevented from entering the storage space 220 by the air discharged from the exhaust port 25.

Further, by orienting the direction of the air discharged from the exhaust port 25 toward the side on which the electric work section 3 is provided in the left-right direction (the lower side in FIG. 3), it is possible to further prevent foreign matter such as sawdust from entering the storage space 220.

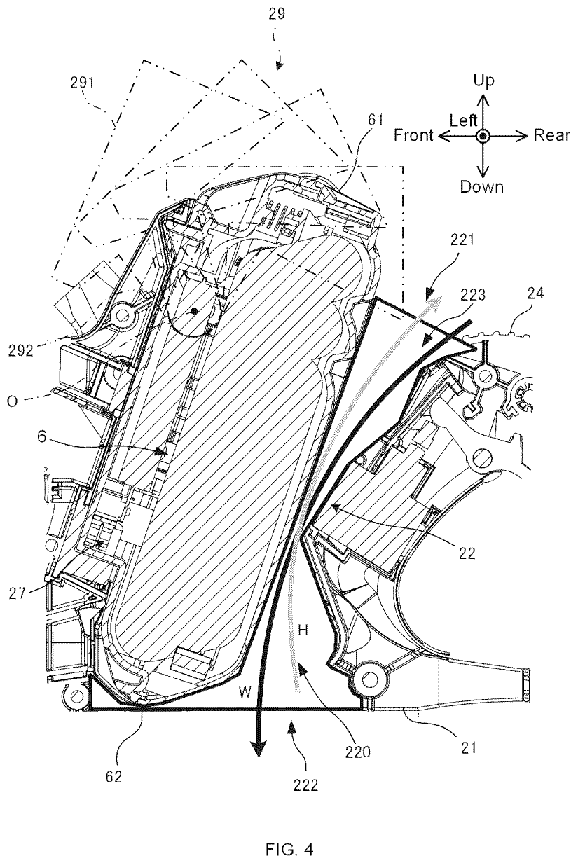

As shown in FIG. 4, the battery compartment 22 forms a gap 223 with respect to the battery 6 in a state where the battery 6 is inserted (stored) in the storage space 220. The gap 223 is open upward in the battery compartment 22 at the first opening 221 and also open downward in the battery compartment at the second opening 222. In other words, gap 223 penetrates the main body section 2 (battery compartment 22) vertically even when the battery 6 is stored in the storage space 220.

In addition, the upper main body section 2 includes a cover 29 attached to the battery compartment 22 so as to cover the battery 6 from above, as shown in FIG. 1 and FIG. 4. The cover 29 is configured, in a state of being mounted to the battery compartment 22, to expose the gap 223 to the outside, with covering the side of the upper end 61 of the battery 6 while not covering the upper side of the gap 223.

According to this configuration, water W, such as rainwater, is discharged to the outside from the lower side of the battery compartment 22 through the gap 223. Therefore, adverse effects (e.g., electric leakage or corrosion) on the battery 6 and other electrical components can be suitably prevented. In addition, the heat H generated by the battery 6 is not accumulated inside the battery compartment 22 but is discharged to the outside from the upper side, thereby sufficiently preventing malfunction of the battery 6.

Further, the cover 29 is rotatably attached to the battery compartment 22. According to this configuration, the battery 6 can be attached to and removed from the battery compartment 22 relatively easily.

The cover 29 includes a cover body 291 covering the battery 6 and a leg 292 connected to the cover body 291 and fixed to the battery compartment 22. In the present embodiment, as shown in FIG. 1, the lower end of the leg 292 is rotatably attached to the main body section 2 (battery compartment 22) at rotary shaft portion 292a.

As a result, the cover 29 is configured to rotate between the first position in which the battery 6 covered, and a second position in which the cover is rotated forward to expose the battery 6 to the outside. According to this configuration, the cover body 291 of the cover 29 in the first position can cover the battery 6 and the electric components located below the battery 6, thereby more effectively preventing adverse effects on the electric components caused by water W.

In the present embodiment, the battery compartment 22 includes a connection terminal 27 located ahead of the gap 223, the connection terminal being electrically connected to the battery 6. According to this configuration, it is particularly easy to protect the connection terminal 27, which is susceptible to adverse effects caused by water W.

In addition, as shown in FIG. 1, the cover body 291 of the cover 29 in the first position covers the vicinity of the top 28 of the cover body 2 (the front boundary between the battery compartment 22 and the battery 6), which further effectively prevents water W from contacting the connection terminal 27.

Further, as shown in FIG. 4, the center of rotation O of cover 29 is positioned, in the front-rear direction, between the connection terminal 27 and the gap 223. According to this configuration, it is easy to prevent water W from entering the front boundary between the battery compartment 22 and the battery 6, even when the cover 29 is rotated from the first position to the second position.

The cover 29 is provided so that the tip position thereof is forward of the end of the battery housing position 22 (top 28 of the main part 2) on the connection terminal 27 side. According to this configuration, the center of rotation O of the cover 29 is located on the side of the connection terminal 27, which enables to prevent or suppress the entry of water between the battery 6 and the battery compartment 22 even when the water adhering to the cover 29 due to the rotation of the cover 29 flows forward of the main body section 2.

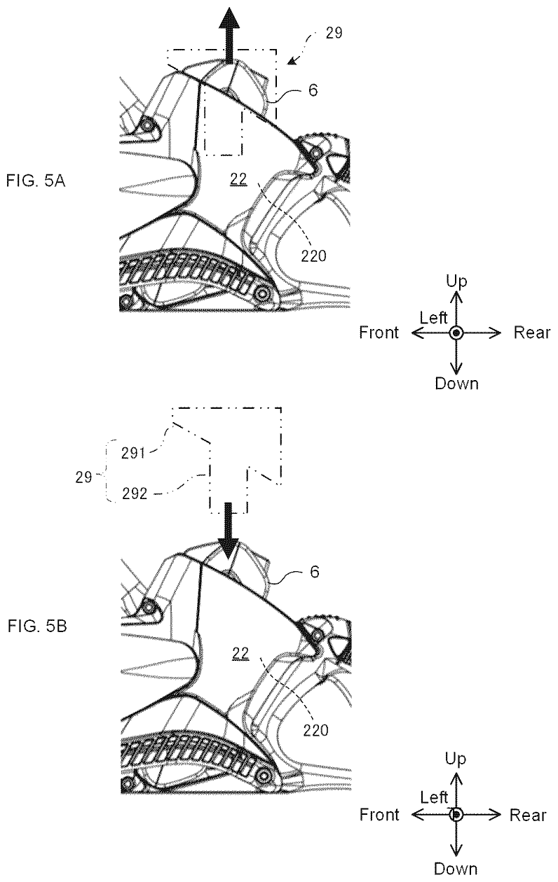

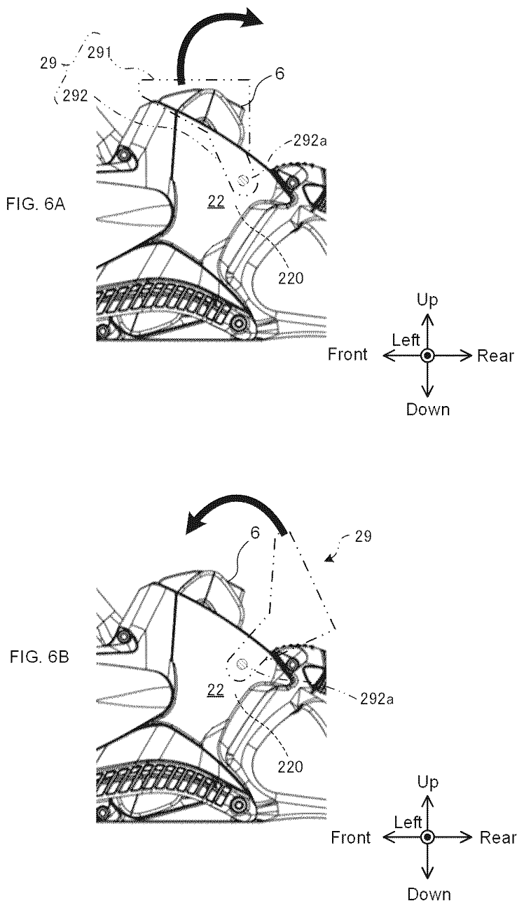

The cover 29 may also adopt the configurations shown in FIGS. 5 and 6.

FIGS. 5A to 6B show other configuration examples of the cover, respectively.

The cover 29 shown in FIGS. 5A and 5B is configured to be mounted in the battery compartment 22 by sliding the cover 29 in the vertical direction.

The cover 29 shown in FIGS. 6A and 6B includes a rotary shaft 292a at a position corresponding to the gap 223 in the battery compartment 22. The cover 29 is configured to rotate between the first position in which the battery 6 is covered, and the second position in which the battery 6 is exposed outside by rotating rearward.

The present disclosure is not limited thereto, although the embodiment as described above describes a chainsaw as an example of an electric power tool. The electric power tool may be, for example, hedge trimmers, power cutters, blowers, and the like. In other words, as long as a battery is mounted in the battery compartment of the main body section and the tool includes an electric work section that operates with electric power supplied from this battery, any electric power tool may be employed.

In addition, it may be provided in each of the aspect.

(1) An electric power tool, including: a main body section including: a battery compartment configured to form a gap opening upward with respect to a battery in a state where the battery is inserted from above, and a cover attached to the battery compartment so as to cover the battery from above, the cover being configured to expose the gap to outside when attached to the battery compartment; and an electric work section provided at a front side of the main body section and configured to operate with power supplied from the battery.

(2) The electric power tool according to (1) wherein the cover is rotatably attached to the battery compartment.

(3) The electric power tool according to (2), wherein the cover is configured to rotate between a first position in which the battery is covered, and a second position in which the cover moves forward to expose the battery to outside.

(4) The electric power tool according to any one of (1) to (3), wherein the gap is also open downward in the battery compartment.

(5) The electric power tool according to any one of (1) to (4), wherein the battery compartment includes a connection terminal located ahead of the gap, the connection terminal being electrically connected to the battery.

(6) The electric power tool according to (5), wherein the cover is rotatably attached to the battery compartment, and a center of rotation thereof is positioned, in a front-rear direction, between the connection terminal and the gap.

(7) The electric power tool according to any one of (1) to (6), wherein the cover includes: a cover body covering the battery; and a leg connected to the cover body and fixed to the battery compartment.

Of course, the present disclosure is not limited thereto.

Finally, various embodiments pertaining to the present disclosure have been described, which are presented as examples and are not intended to limit the scope of the disclosure. The novel embodiment can be implemented in various other forms, and various omissions, substitutions, and changes can be made without departing from the scope of the disclosure. Embodiments and variations thereof are included in the scope and gist of the invention as well as within the scope of the invention and the equivalents thereof according to the claims.

What is claimed is:

1. An electric power tool, comprising:
a main body section including:
a battery compartment configured to form a gap opening upward with respect to a battery in a state where the battery is inserted from above, and
a cover attached to the battery compartment so as to cover the battery from above, the cover being configured to expose the gap to outside when attached to the battery compartment; and
an electric work section provided at a front side of the main body section and configured to operate with power supplied from the battery.

2. The electric power tool according to claim 1, wherein
the cover is rotatably attached to the battery compartment.

3. The electric power tool according to claim 2, wherein
the cover is configured to rotate between a first position in which the battery is covered, and
a second position in which the cover moves forward to expose the battery to outside.

4. The electric power tool according to claim 1 wherein
the gap is also open downward in the battery compartment.

5. The electric power tool according to claim 1 wherein
the battery compartment includes a connection terminal located ahead of the gap, the connection terminal being electrically connected to the battery.

6. The electric power tool according to claim 5, wherein
the cover is rotatably attached to the battery compartment, and a center of rotation thereof is positioned, in a front-rear direction, between the connection terminal and the gap.

7. The electric power tool according to claim 1 wherein
the cover includes:
a cover body covering the battery; and
a leg connected to the cover body and fixed to the battery compartment.
